(19) United States
(12) Patent Application Publication
(10) Pub. No.: US 2006/0241251 A1
(43) Pub. Date: Oct. 26, 2006

(54) Coherent Insert

(75) Inventor: Dean Anthony Bugg, Cambridge (GB)

Correspondence Address: Legal Department;Huntsman Corporation, 10003 Woodloch Forest Drive, The Woodlands, TX, 77380, US

(73) Assignee: Huntsman Advanced Material Americas Inc., The Woodlands, TX (US)

(21) Appl. No.: 11/471,870

(22) Filed: Jun. 21, 2006

Related U.S. Application Data
(63) Continuation of application No. 10/258,204, filed on Dec. 26, 2002.

(30) Foreign Application Priority Data
Apr. 20, 2000 (EP) 00810351.7
May 4, 2000 (GB) 0010737.5

(51) Int. Cl. C08L 63/00

(52) U.S. Cl. 525/523; 523/444

(57) ABSTRACT

A coherent insert, in particular for filling a three-dimensional cavity, especially a cavity in the core of a sandwich-type composite, which insert is solid at ambient temperature, characterized in that the insert consists of a solid curable composition, which expands and is able to adhesively bond when heat-cured.

The instant invention relates to a coherent insert, in particular for filling a three-dimensional cavity, more particularly a cavity in the core of a sandwich-type composite, a process for manufacturing said insert and a process for filling a three-dimensional cavity using said insert.

The use of solid coherent inserts for filling a three-dimensional cavity is known. The known inserts are, for instance, of cylindrical shape and consist of a syntactic plastic material, for instance a corresponding cured epoxy material. “Syntactic” is understood to mean a material comprising hollow microspheres as filler, thereby being of rather low density and having good mechanical performance. These inserts are particularly useful for reinforcing sandwich panels like, for instance, honeycomb-type composites. The reinforcing process using such a cylindrical insert includes the removement of a circular section of the core of the panel in the area where the panel is to be reinforced. Then an expanding splice adhesive tape is cut to the required size and wrapped around the insert. After the release film is removed from the tape, the insert can be installed in the honeycomb panel cavity. Finally, the assembly of core material, insert, adhesive tape and, optionally, additional skin material covering the outer sides of core material is co-cured at a suitable temperature to form a reinforced composite structure.

It is an objective of the instant invention to facilitate the application of solid inserts. In this regard it has surprisingly been found that the use of a separate adhering vehicle for fastening the insert into the surrounding panel like the splice tape mentioned beforehand can be avoided if specific solid inserts are used.

Accordingly, on subject of the instant invention is a coherent insert, in particular for filling a three-dimensional cavity, more particularly a cavity in the core of a sandwich-type composite, which insert is solid at ambient temperature and is characterized in that it consists of a solid curable composition, which expands and is able to adhesively bonding when heat-cured.

For the puropses of this application “ambient temperature” means preferably a temperature below of 35° C., for instance 10 to 30° C. “Coherent” means that the insert is at ambient temperature a solid preformed monolithic article, and not powdery.

The inserts according to the invention consist preferably of a solid expandable curable epoxy composition.

This solid curable epoxy compositions is particularly a composition comprising:
(A) an epoxy resin or an epoxy containing compound with
(B) a solidifying amine system which reacts with (A) to give a product, preferably with a Kofler Heat Bank melting point of between 55° and 120° C., which is not present in sufficient quantities to allow or cause chemical gelation under the reaction conditions chosen for (A) and (B) and which essentially stops solidifying before or when all its active epoxy additive hydrogen groups are consumed by the epoxy groups,
(C) a hardener system for (A) and the reaction product of (A) and (B) which is different from (B) and which remains substantially unreacted under the conditions of reaction chosen for (A) with (B),
(D) an expanding agent which is of low or preferably no reactivity under the condition of reaction chosen for (A) and (B), and, optionally
(E) customary additives,
   which composition has been solidified by reaction of (A) with (B) under conditions under which (C) does substantially not react with (A) and the reaction product of (A) and (B).

Such compositions are, for instance, described in more detail in WO-A-97/19124.

Before solidifying then composition by reacting (A) and (B) the components (A), (B), (C), (D) and (E) are blended together by any convenient batch or continuous operation but in such a way that at least (A) and (B) become homogeneous. The reaction between (A) and (B) may be carried out at any suitable temperatue and condition provided that neither it, nor the exothermic heat generated from it causes (C) or (D) to substantially react whilst it is taking place.

The epoxy resins or epoxy group containing compounds (A) may be glycidyl ethers, glycidyl amines, glycidyl esters or cycloaliphatic compound or combinations of these including halogenated versions where required. Preferred epoxy resins and blends are those which are suitable liquids for ready mixing with the other ingredients at suitable temperatures which will usually be below 120° C. Epoxy resins or epoxy containing compounds or blends of them which are liquid at room temperatures are the most convenient.

The preferred solidifying systems (B) used to convert the liquid resins are principally compounds or mixtures of compounds whose most reactive groups relative to the epoxy materials employed are primary or secondary amines. Epoxy reactive tertiary amines under the conditions of reaction chosen for (A) and (B) are not acceptable for this invention.

Of particular use for component (B) are aromatic and cycloaliphatic primary and secondary amines and blends of these. The major advantage of these amines, particularly the aromatic amines, is the low rate of reactivity coupled with the extremely long life at normal ambient temperatures of their reaction products with the resins. With the majority of compounds from these classes of amines the life of the reaction product with the resins greatly exceeds that of the life of the resins with their primary hardeners (C). Some alicyclic, heterocyclic and aliphatic amines are also effective as advancing agents and those which comply with cessation of reaction once their amino hydrogen atoms have been consumed by the epoxy resins and considered as part of this invention. In all cases it is essential that the tertiary amines generated during the solidification reaction have very low reactivity with epoxy groups under the conditions of reaction chosen for (A) and (B) and afterwards during storage. The solidifying amines are usually and mostly difunctional and/or polyfunctional with respect to the epoxy compounds (A) although monofunctional amines can be used to some extent if of value to a particular composition.

Difunctional amines may be used at any desired ratio with difunctional epoxy resins but greater than difunctional amines only to levels where gelation does not occur. The solidifying systems may contain a variety of other groups but these should only be of very low or no reactivity towards the epoxy groups involved under the reaction of (A) and (B). Most useful are those solidifying systems which react gradually to substantial completion at room temperatures over a period of around 2-14 days. The solidifying systems must be present in such quantities that when their amino hydrogen atoms are all substantially reacted with the epoxy materials (A) under the conditions set for reaction (A) and (B) the product is not chemically gelled and has a melting point which is preferably greater than 55° C. and lower than 120° C.

The hardener systems, (C) for the epoxy compounds (A) and the reaction products between (A) and (B) can be selected from the wide variety of those well known in the field of epoxy chemistry other than acid anhydrides which react preferentially with the advancing agents (B). Typical but not exclusive examples of useful hardeners are aromatic amines such as diaminodiphenyl sulphones, boron trifluoride amine. complexes, latent imidazoles, carboxylic acids, biguanides, hydrazides, dicyandiamide, latent epoxy amine adducts and substituted ureas. As explained a main requirement of the hardener is that it should not substantially react whilst (A) and (B) are being reacted. There may be one or several hardeners used together, some of which may accelerate the curing rates of the other provided they comply with the requirement immediately above.

The expanding agents (D) may be of any type which does not adversely interfere with the production of the solid epoxy composition nor its ability to cure satisfactorily. The expansion obtained may result from chemical or physical reactions or both. An important feature is that the foaming agent should not cause substantial foaming during the process for the production of the solid epoxy compositions, nor on storage of it in any form at normal workshop temperatures or below. All significant expansion should take place during the actual curing cycles. Examples of suitable expanding agents include Azodicarbonamide, Azodiisobutyronitrile, Benzene sulphonhydrazide, Dinitroso pentamethylene tetramine, Oxybis benzene sulphonhydrazide, p toluene sulphonyl hydrazide and Expandable plastic such as those sold under the Trade Name Expancel. These are largely spherical shells of varying composition such as polyvinylidene chloride and or polyacrylonitrile plus other copolymerised additives, and the inside contains isopentane with or without air.

Other additives, (E) which can be used to modify the physical properties of the cured or uncured compositions include but are not limited to accelerators for the hardener (C), thixotropes, toughening agents, wetting agents, surfactants, fibrous materials, dyes, pigments flame retardants, smoke suppressants, coupling agents, flow assisting materials, fusible glasses and stabilisers.

Still another type of important additives are fillers which can be used in a wide variety for the purposes of the instant invention, either singly or in form of a mixture of two or more than two different fillers.

Whereas any filler materials can, in general, be used for the instant invention, suitable fillers particularly include hollow microspheres, for instance made of glass, carbon, silicates or a variety of plastic materials. A common feature of these microspheres is their low density, which is also imparted to the paste and is the prime reason for their use. An additional consideration.is the relative ease they give to the cured composition for sanding or smoothing.

Another type of fillers to be particularly mentioned here are electrically conductive fillers. The presence of such fillers allows to heat the curable composition inductively with the aid of an induction coil for instance, either when manufacturing the coherent inserts according to the invention or when using a ready-for-use-insert for filling a cavity as described below.

The above mentioned epoxy compositions can be prepared with either low or high melt viscosities as required through the careful selection of (A) and (B). They cure within 30 minutes to a few hours at 100 to 150° C., for instance at about 120° C. or within a few at 180° C. to 260° C., dependent on the selection of (C). Furthermore, a wide range of desired mechanical and thermal properties by the careful selection of (A), (B) and (C), and a ready modification of physical and mechanical properties may also be achieved by the introduction of additives (E).

The inserts according to the invention are preferably storage stable at ambient tempertures, more particular storage stable for three month and more at ambient temperatures, especially for more than 6 months.

The inserts according to the instant invention can, for instance, be manufactured with the aid of a process wherein an expandable curable composition, which is solid at ambient temperature, for example a corresponding epoxy composition, is formed to a desired shape under conditions where it does neither substantially expand nor gel or cure. Said process is a further object of the instant invention.

To this purpose, a solid expandable curable composition can for instance be melted under sufficiently mild conditions where it does neither substantially expand nor gel or even cure and cast into the desired physical form, using for instance a mould.

In another specific embodiment of the above mentioned process a liquid solidifiable composition is solidified to form the expandable curable composition which is solid at ambient temperature.

If, for instance, a compositions as described in WO-A-97/19124 and as mentioned above is used for manufacturing inserts according to the invention the solidification of the liquid starting composition can be carried out by allowing it to stand for a time period of some hours to some days (for instance from 5 hours to 14 days) at ambient temperature. Should it be desirable to speed the solidification this can be achieved by heating provided the temperature used does not cause significant reaction of (C) with (A) or the reaction product of (A) and (B), either by direct heat or that evolved by completing the reaction between (A) and (B) or by the addition of accelerators such as carboxylic acids which do not adversely affect the softening point stability

The solidification of the liquid composition can, of course, also be carried out under simultanous shaping of the insert.

Still another aspect of the instant invention is a process for filling a three-dimensional cavity in a first material, for instance a honeycomb material, wherein an insert according to the instant invention is put into the cavity and is heated, preferably under pressure, whereby the curable composition comprised in the insert melts, expands and cures, thereby filling the cavity in the first material substantially complete.

In an specific embodiment of said process the cavity is covered on at least one side with a suitable covering material before heating and the covering material is adhesively bonded to said first material by means of the heating.

The inserts according to the instant invention are well suited provide support for load bearing elements like nails or screws and so on in materials where such support is normally not available, for instance honeycomb-type materials. Therefore a specific embodiment of the above described process for filling a cavity in a material includes a process step wherein a load bearing element is fixed to the insert.

As mentioned above the heating can be carried out, for instance, inductively. It is, of course, clear that the insert must comprise sufficient electrically conductive material in order to be able to be inductively heated. This electrically conductive material can be a particulate material like an electrically conductive filler or an electrically conductive compact object incorporated into the insert, for instance a metallic nail or screw.

### EXAMPLE 1

### Manufacture of Self Adhesive Expandable Inserts According To the Invention

| | |
|---|---|
| Araldite GY260 (Bisphenol A Epoxy resin from Ciba SC) | 100 pbw |
| Dicyanamide | 4.3 pbw |
| Chlorotoluron | 2.2 pbw |
| 3,3′-dimethyl 4,4′-diamino dicyclohexyl methane | 10.6 pbw |
| Cyclohexylamine | 6.0 pbw |
| Eccospheres IG 101 (hollow microsperes) | 50 pbw |
| Expancel 551 DU (Unexpanded thermoplastic microsheres) | 1.5 pbw |

All of the components of the above formulation are thoroughly mixed together using a mechanical mixer under vacuum for 5 minutes. The mixture is transferred to cylindrical moulds of dimensions 25.4 mm in height and a diameter of 12.7 mm. Then the mixture is allowed to stand at room temperature for about 17 hours followed by heating for 2 hours at 60° C. The samples are allowed to cool to 23° C. and the samples were solid.

### EXAMPLE 2

Solid cylindrical blocks made according to Example 1 are kept in the moulds but with the top surface open. The samples and moulds are placed in an oven at 120° C. for 60 minutes. The mould and samples are then removed and allowed to cool back to room temperature. When the samples are removed from the oven it can be seen that the samples have increased in volume. The density of the sample before curing is 0.66 g/cm³ and the density of the sample after curing is 0.52 g/cm³. The compressive properties of the samples are measured according to the test specification ASTM D695. The following results are obtained:

| | |
|---|---|
| Compressive strength at 23° C. | 37.5 MPa |
| Compressive modulus at 23° C. | 1182 MPa |
| Compressive strength at 177° C. | 7.7 MPa |
| Compressive modulus at 177° C. | 127 MPa |

### EXAMPLE 3

The compositions 3/1 to 3/9 given in Table 1 and Table 2 were processed analogous to Example 1. The detailed processing conditions can also be found in said tables, as well as the properties of the samples when processed according to Example 2.

### EXAMPLE 4

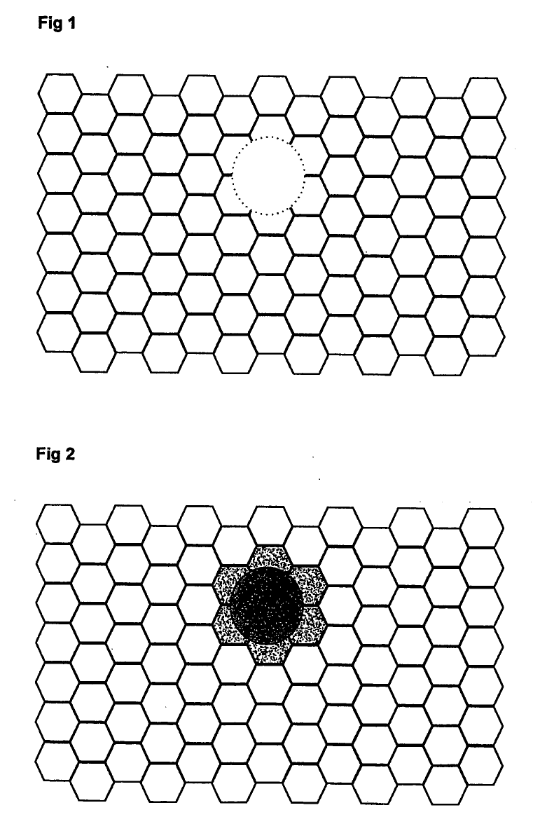

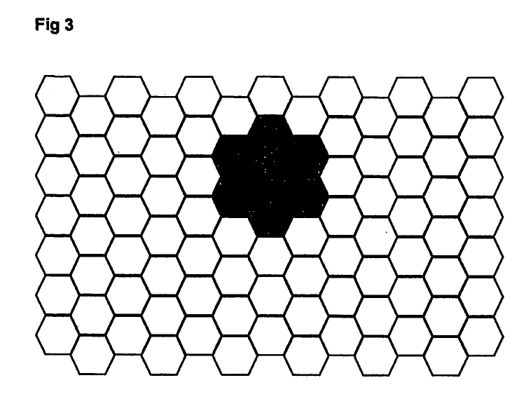

A cylindrical insert is made according to Example 1 having a height of 12.5 mm and a diameter of 25 mm. Aluminium honeycomb with depth of 12.5 mm and an average cell diameter of 6 mm is placed on an aluminium plate. A circular hole is cut out of the aluminium honeycomb with a diameter of 25 mm (see FIG. 1 below). The solid insert is placed into the circular hole and another aluminium plate is placed on top to from a sandwich panel (FIG. 2). The panel is placed in a hydraulic press and 300 kPa pressure are applied. The temperature of the press plates is raised from room temperature to 120° C. over a period of 30 minutes and the panel remains in the press at 120° C. for 1 hour. The panel is then removed and allowed to cool to room temperature. The three aluminium components adhere together and on disassembly it can be seen that the insert has expanded to fill the uneven edges of hole and adheres to them (FIG. 3)

TABLE 1

| Components | 3/1 | 3/2 | 3/3 | 3/4 | 3/5 |
|---|---|---|---|---|---|
| Araldite GY260 | 100 | 100 | 100 | 100 | 100 |
| Dicyanamide | 4.3 | 4.3 | 4.3 | 4.3 | |
| Chlorotoluron | 2.2 | 2.2 | 2.2 | 2.2 | |
| HY2954 | 10.6 | 10.6 | 10.6 | 10.6 | 10 |
| Cyclohexylamine | 6.0 | 6.0 | 6.0 | 6.0 | |
| Eccospheres IG 101 | 50.0 | 50.0 | 50 | 50 | 20 |
| Expancel 551 DU | 1.5 | 1.5 | — | — | 0.5 |
| AIBN | — | — | — | 0.2 | |
| Metalinks | — | — | — | — | |
| Diaminodiphenylsulphone | | | | | 18 |
| Phoschek P30 | | | | | 25 |
| Paraloid EXL 2600 | | 10.0 | | | |
| Advancement Schedule | 16 hours at 23° C. + | 16 hours at 23° C. + | 16 hours at 23° C. + | 16 hours at 23° C. + | 16 hours at 23° C. + |
| | 2 hours at 60° C. | 2 hours at 60° C. | 2 hours at 60° C. | 2 hours at 60° C. | 2 hours at 60° C. |
| Cure Schedule | 1 hour at 120° C. | 1 hour at 120° C. | 1 hour at 120° C. | 1 hour at 120° C. | 3 hours at 177° C. |
| Density g/cm³ (Advanced) | 0.66 | 0.69 | 0.68 | 0.62 | |
| Density g/cm³ (Cured) | 0.52 | 0.59 | 0.61 | 0.46 | 0.90 |
| Compressive Strength | 37.49 | 50.93 | 64.16 | 27.3 | 80.5 |
| (MPa) at 23° C. | | | | | |
| Compressive Modulus | 1182 | 1448 | 1939 | 1315 | 2024.7 |
| (MPa) at 23° C. | | | | | |
| Compressive Strength | 7.7 | | | | 11.1 |
| (MPa) at 177° C. | | | | | |
| Compressive Modulus | 127 | | | | 99.2 |
| (MPa) at 177° C. | | | | | |
| Aluminium Lap Shear | 12.9 | 15.0 | | | |
| Strength (MPa) | | | | | |

TABLE 2

| Components | 3/6 | 3/7 | 3/8 | 3/9 |
|---|---|---|---|---|
| Araldite GY260 | 100 | 100 | 100 | 100 |
| Dicyanamide | — | — | 4.3 | — |
| Chlorotoluron | — | — | 2.2 | — |
| HY2954 | 10 | — | 10.6 | 10.6 |
| Cyclohexylamine | — | 10 | 6.0 | 6.0 |
| Eccospheres IG 101 | 20 | 20 | — | 10 |
| Expancel 551 DU | 0.5 | 0.5 | 1.5 | 1.5 |
| AIBN | — | — | — | — |
| Metalink H | — | — | — | 48.0 |
| Diaminodiphenylsulphone | 18 | 34.5 | — | — |
| Phoschek P30 | 25 | 25 | — | — |
| BF₃-monoethylamine | 0.6 | 1.0 | — | — |
| Advancement Schedule | 16 hours at 23° C. + 2 | 16 hours at 23° C. + 2 | 16 hours at 23° C. + 2 | 16 hours at 23° C. + 2 |
| | hours at 60° C. | hours at 60° C. | hours at 60° C. | hours at 60° C. |
| Cure Schedule | 3 hours at 177° C. | 3 hours at 177° C. | 1 hour at 120° C. | 1 hour at 120° C. |
| Density g/cm³ (Advanced) | | | 1.3 | 1.0 |
| Density g/cm³ (Cured) | 0.91 | 0.90 | 1.3 | 0.9 |
| Compressive Strength | 64.0 | 68.1 | 117.5 | 49.1 |
| (MPa) at 23° C. | | | | |
| Compressive Modulus | 1475.8 | 1718 | 2027 | 1823 |
| (MPa) at 23° C. | | | | |
| Compressive Strength | 14.3 | 33.9 | | |
| (MPa) at 177° C. | | | | |
| Compressive Modulus | 325.9 | 926.6 | | |
| (MPa) at 177° C. | | | | |
| Lap Shear Strength (MPa) | | | 39.8 | 4.1 |

1-15. (canceled)

16. A process for filling a three-dimensional cavity in a first material wherein a coherent insert which is solid and storage stable at a temperature of 10° C. to 30° C. and which consists of a solid expandable curable epoxy composition comprising:
(A) an epoxy resin or an epoxy containing compound with
(B) a solidifying primary or secondary amine system which reacts with (A) to give a product with a Kofler Heat bank melting point of between 55° and 120° C., which is not present in sufficient quantities to allow or cause chemical gelation under the reaction conditions chosen for (A) and (B) and which essentially stops solidifying before or when all its active epoxy additive hydrogen groups are consumed by the epoxy groups,
(C) a hardener system for (A) and the reaction product of (A) and (B), other than an acid anhydride, which is different from (B) and which remains unreacted under the conditions of reaction chosen for (A) with (B),
(D) an expanding agent which remains unreacted under the condition of reaction chosen for (A) and (B), and optionally
(E) other additives,
which composition has been solidified by reaction of (A) with (B) under conditions under which (C) does not react with (A) and the reaction product of (A) and (B), and which expands and is able to adhesively bond when heat-cured when put into the three-dimensional cavity and heated, whereby the curable epoxy composition comprised in the coherent insert melts, expands and cures, thereby completely or substantially filling the three-dimensional cavity in the first material and wherein the heating is carried out inductively.

17. The process according to claim 16 wherein the hardener system for (A) and the reaction product of (A) and (B) is selected from the group consisting of an aromatic amine, a latent imidazole, a carboxylic acid, a biguanide, a hydrazide, a dicyandiamide, a latent epoxy amine adduct and a substituted urea.

18. The process according to claim 16 wherein the expanding agent is selected from the group consisting of azodicarbonamide, azodiisobutyronitrile, benzene sulphonhydrazide, dinitroso pentamethylene tetramine, oxybis benzene sulphonhydrazide, p toluene sulphonyl hydrazide and expandable plastic.

19. The process according to claim 16 wherein the other additives comprises a filler.

20. The process according to claim 19 wherein the filler comprises hollow micro spheres.

21. The process according to claim 16 wherein the other additives comprise an electrically conductive material.

22. The process according to claim 16 wherein the first material is a honeycomb material.

23. A process for filling a three-dimensional cavity in a first material wherein a coherent insert which is solid and storage stable at a temperature of 10° C. to 30° C. and which has been formed from a liquid solidifiable composition which consists of an expandable curable epoxy composition comprising:
(A) an epoxy resin or an epoxy containing compound with
(B) a solidifying primary or secondary amine system which reacts with (A) to give a product with a Kofler Heat bank melting point of between 55° and 120° C., which is not present in sufficient quantities to allow or cause chemical gelation under the reaction conditions chosen for (A) and (B) and which essentially stops solidifying before or when all its active epoxy additive hydrogen groups are consumed by the epoxy groups,
(C) a hardener system for (A) and the reaction product of (A) and (B), other than an acid anhydride, which is different from (B) and which remains unreacted under the conditions of reaction chosen for (A) with (B),
(D) an expanding agent which remains unreacted under the condition of reaction chosen for (A) and (B), and optionally
(E) other additives,
which composition has been solidified by reaction of (A) with (B) under conditions under which (C) does not react with (A) and the reaction product of (A) and (B), and which expands and is able to adhesively bond when the coherent insert is put into the three-dimensional cavity and heated, whereby the curable epoxy composition comprised in the coherent insert melts, expands and cures, thereby completely or substantially filling the three-dimensional cavity in the first material and wherein the heating is carried out inductively, and wherein prior to putting the coherent insert into the cavity the coherent insert has been formed to a desired shape under conditions where it does neither expand nor gel or cure.

24. The process according to claim 23 wherein the solidification of the liquid composition is carried out under simultaneous shaping of the coherent insert.

25. The process according to claim 23 wherein the hardener system for (A) and the reaction product of (A) and (B) is selected from the group consisting of an aromatic amine, a latent imidazole, a carboxylic acid, a biguanide, a hydrazide, a dicyandiamide, a latent epoxy amine adduct and a substituted urea.

26. The process according to claim 23 wherein the expanding agent is selected from the group consisting of azodicarbonamide, azodiisobutyronitrile, benzene sulphonhydrazide, dinitroso pentamethylene tetramine, oxybis benzene sulphonhydrazide, p toluene sulphonyl hydrazide and expandable plastic.

27. The process according to claim 23 wherein the other additives comprise a filler.

28. The process according to claim 27 wherein the filler comprises hollow microspheres.

29. The process according to claim 23 wherein the other additives comprise an electrically conductive material.

30. The process according to claim 23 wherein the first material is a honeycomb material.
